(19) United States
(12) Patent Application Publication
(10) Pub. No.: US 2011/0007506 A1
(43) Pub. Date: Jan. 13, 2011

(54) LIGHTING APPARATUS

(75) Inventor: Junichi Kinoshita, Ehime (JP)

Correspondence Address: OBLON, SPIVAK, MCCLELLAND MAIER & NEUSTADT, L.L.P., 1940 DUKE STREET, ALEXANDRIA, VA, 22314, US

(73) Assignee: Harison Toshiba Lighting Corp., Imabari-shi (JP)

(21) Appl. No.: 12/867,995

(22) PCT Filed: Jan. 27, 2009
(86) PCT No.: PCT/JP09/51276

§ 371 Date: Aug. 17, 2010

(30) Foreign Application Priority Data
Apr. 11, 2008 (JP) 2008-103990
Apr. 11, 2008 (JP) 2008-103991

(51) Int. Cl. F21V 7/00

(52) U.S. Cl. 362/235; 362/296.01

(57) ABSTRACT

A thin, linear or planar lighting apparatus with a hollow cavity having a uniform luminance distribution over a lighting surface. The lighting apparatus includes a light source configured to emit light having a narrow-angle light intensity distribution characteristic, a diffuser plate disposed in a position spaced apart by a predetermined distance from an optical axis of the light emitted from the light source, and a reflection member. The reflection member includes a level surface substantially parallel to the optical axis and an inclined surface inclined to the optical axis at a predetermined angle so that a uniform illuminance distribution over a lighting surface is achieved. A hollow region is formed between the diffuser plate and the reflection member, and the diffuser plate is illuminated with light reflected off the level surface and the inclined surface via the hollow region.

### TECHNICAL FIELD

The present invention relates to a lighting apparatus and particularly to a lighting apparatus with a linear or planar lighting surface.

### BACKGROUND ART

A surface illuminating apparatus configured to produce surface emission from one or more surface regions by using light emitted from an LED (Light Emitting Diode), an LD (Laser Diode), or any other suitable solid state light emitting device, any of which is a point light source, has been widely used in a backlight apparatus and other similar apparatus.

To convert light fluxes from a plurality of light emitting devices into linear or planar emission, the following two methods can be used: a light guide plate method in which light from a linear light source disposed sideways to a light guide plate is introduced into the light guide plate and the thus introduced light illuminates a diffuser plate disposed above the light guide plate (one-dimensional light source array method), and a direct method in which a diffuser plate is disposed over a plurality of LEDs arranged in a matrix and the light from the LEDs illuminates a surface of the diffuser plate and causes the diffuser plate to radiate light (two-dimensional light source array method) (see Japanese Patent Application Laid-Open Publication No. 2005-316337, for example).

FIG. 18 is a perspective view showing an example of a surface illuminating apparatus using the light guide plate method. FIG. 19 is a perspective view showing an example of a surface illuminating apparatus using the direct method. In FIG. 18, light fluxes emitted from a plurality of LEDs 101 disposed in a side surface portion are introduced into a light guide plate 102, undergo repeated surface reflection in the light guide plate 102, and spread over a wide area of the light guide plate 102. Planar emission is thus produced through a diffuser plate 103. In FIG. 19, a diffuser plate 103 is disposed over a plurality of LEDs 101 arranged in a matrix on a bottom substrate, and the light fluxes emitted from the LEDs 101 exit through the diffuser plate 103 upward. Planar emission is thus produced.

The two methods, however, have the following disadvantages: In the light guide plate method, the light guide plate 102 is thin and lightweight only when the size thereof is small, but is heavy when the area thereof is large. In the direct method, a long distance to the diffuser plate 103 is required to diffuse and homogenize the spots of the light fluxes emitted from the array of point light sources, resulting in a large total thickness.

To address the disadvantages described above, a hollow cavity method has been proposed as a third method (see Japanese Patent Application Laid-Open Publication No. 2006-106212 and K. Kalantar and M. Okada, “RGB-LED Backlighting Monitor/TV for Reproduction of Images In Standard and Extended Color Spaces,” IDW 04 Digest, pp. 683-686 (2004), for example). FIG. 20 is a cross-sectional view showing an exemplary configuration of a surface illuminating apparatus using the hollow cavity method.

The surface illuminating apparatus using the hollow cavity method shown in FIG. 20 has a simple hollow cavity structure in which bottom reflection plates 111, 112 and a top diffuser plate 103 are provided and a plurality of LED light sources 101 are linearly disposed on a side surface. The surface illuminating apparatus using the hollow cavity method, although light is emitted from the LED light sources 101 on the side surface, has an advantage of being lightweight because no light guide plate is provided. Further, since light is incident on the reflection plates 111, 112 and the diffuser plate 103 at relatively shallow angles, the distance from the bottom surface to the diffuser plate 103, that is, the thickness of the apparatus, does not need to be long to remove the emitted light spots, unlike in the direct method.

However, the reflection plate 111 is inclined downward from one end thereof facing the light sources 101 toward the bottom surface, and the reflection plate 112 is inclined upward from the other end of the light sources 111. The surface illuminating apparatus using the hollow cavity method shown in FIG. 20 further includes an upper-side reflection plate 113 in the vicinity of the light sources 101, which disadvantageously prevents the hollow cavity portion from being thinner.

An object of the present invention is to provide a linear or planar lighting apparatus using a hollow cavity method that can be thin and make a luminance distribution over a lighting surface uniform.

### DISCLOSURE OF INVENTION

### Means for Solving the Problem

A lighting apparatus of the present invention is a lighting apparatus with a lighting surface including a light source configured to emit light having a narrow-angle light intensity distribution characteristic, a diffuser plate disposed in a position spaced apart by a predetermined distance from an optical axis of the light emitted from the light source, the diffuser plate forming the lighting surface, and a reflection member provided in a position facing the lighting surface so that a uniform illuminance distribution over the lighting surface is achieved, the reflection member including a level reflection surface substantially parallel to the optical axis and an inclined reflection surface inclined to the optical axis at a predetermined angle. A hollow region is formed between the diffuser plate and the reflection member, and the light emitted from the light source is reflected off the level reflection surface and the inclined reflection surface toward the diffuser plate.

### BRIEF DESCRIPTION OF THE DRAWINGS

FIG. 1A is a plan view of a lighting apparatus 1 according to a first embodiment of the present invention;

FIG. 1B is a cross-sectional view taken along the line 1B-1B in FIG. 1A;

FIG. 2 is a partial perspective view for describing the shapes of reflection plates according to the first embodiment of the present invention;

FIG. 3A is a plan view of a lighting apparatus 1A according to a first variation of the first embodiment of the present invention;

FIG. 3B is a cross-sectional view taken along the line 3B-3B in FIG. 3A;

FIG. 4A is a cross-sectional view of a lighting apparatus 1B according to a second variation of the first embodiment of the present invention;

FIG. 4B is a view for describing the light intensity distribution characteristic of the lighting apparatus 1B;

FIG. 5A is a cross-sectional view of a lighting apparatus 1C according to a third variation of the first embodiment of the present invention;

FIG. 5B is a view for describing the light intensity distribution characteristic of the lighting apparatus 1C;

FIG. 6 is a partial perspective view for describing the configuration of a lighting apparatus 1D according to a fourth variation of the first embodiment of the present invention;

FIG. 7 is a partial perspective view for describing the configuration of a lighting apparatus 1E according to a fifth variation of the first embodiment of the present invention;

FIG. 8A is a plan view of a lighting apparatus 1F according to a sixth variation of the first embodiment of the present invention;

FIG. 8B is a cross-sectional view taken along the line 8B-8B in FIG. 8A;

FIG. 9A is a view for describing a variation of a light source;

FIG. 9B is a view for describing another variation of a light source;

FIG. 10A is a plan view of a lighting apparatus 1G according to a second embodiment of the present invention;

FIG. 10B is a cross-sectional view taken along the line 10B-10B in FIG. 10A;

FIG. 11 is a partial perspective view for describing the shape of a reflection member of the lighting apparatus 1G according to the second embodiment of the present invention;

FIG. 12 is a cross-sectional view of a lighting apparatus 1H according to a first variation of the second embodiment of the present invention;

FIG. 13 is a view for describing an example of local area dimming by using LEDs arranged in a two-dimensional array in accordance with a direct method of related art;

FIG. 14 is a view for describing another example of local area dimming by using LEDs arranged in a two-dimensional array based on a direct method of related art;

FIG. 15 is a cross-sectional view of a lighting apparatus 1I according to a second variation of the second embodiment of the present invention;

FIG. 16 is a partial perspective view of the lighting apparatus 1I according to the second variation of the second embodiment of the present invention;

FIG. 17 is a diagrammatic perspective view of a light source 4A according to a third variation of the second embodiment of the present invention;

FIG. 18 is a perspective view showing an example of a light guide plate method;

FIG. 19 is a perspective view showing an example of a direct method; and

FIG. 20 is a cross-sectional view showing an exemplary configuration of a surface illuminating apparatus using a hollow cavity method.

### BEST MODE FOR CARRYING OUT THE INVENTION

The present invention will be described below with reference to embodiments thereof.

### First Embodiment

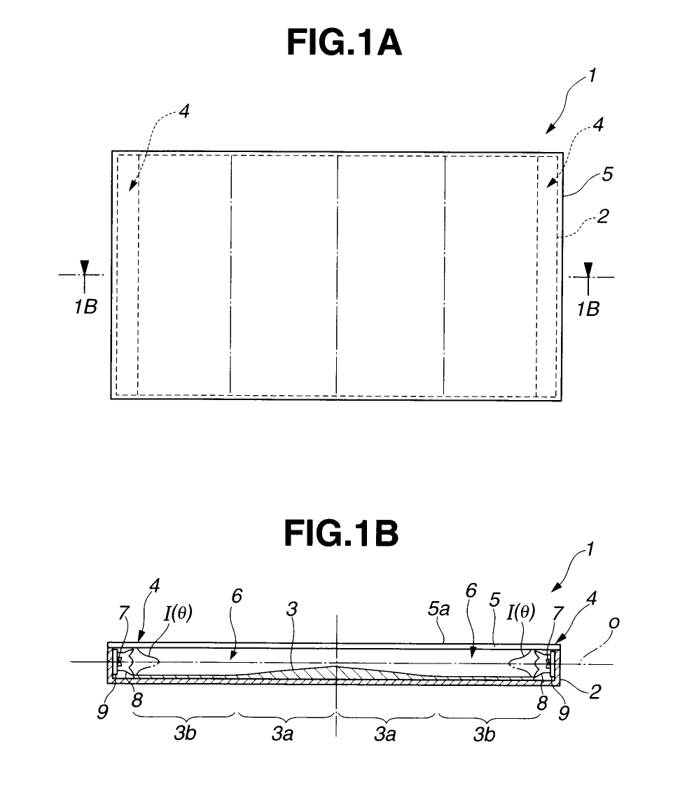

FIG. 1A is a plan view for describing a lighting apparatus 1 according to a first embodiment of the present invention. FIG. 1B is a cross-sectional view taken along the line 1B-1B in FIG. 1A.

The lighting apparatus 1 shown in FIGS. 1A and 1B is a flat panel with a hollow cavity, specifically, a flat LED lighting panel (FL²P), and includes a rectangular lighting surface. The lighting apparatus 1 includes a housing 2, a reflection member 3, a pair of light sources 4, and a diffuser plate 5. The reflection member 3 having a predetermined shape is provided in a bottom surface portion of the box-shaped housing 2. The pair of light sources 4 are disposed in two side surface portions facing each other, and each of the light sources 4 includes a plurality of light emitting devices and a collimator lens. The pair of the light sources 4 face each other in such a way that optical axes O thereof coincide with each other, and each of the light sources 4 emits light having a narrow-angle light intensity distribution characteristic. The diffuser plate 5, which has a shape according to the shape of the housing 2, is provided in an upper surface portion of the housing 2. Two hollow regions 6 are formed between the reflection member 3 and the diffuser plate 5.

The lighting apparatus 1 has a generally thin box-like shape, and an upper surface of the diffuser plate 5 forms a lighting surface 5a.

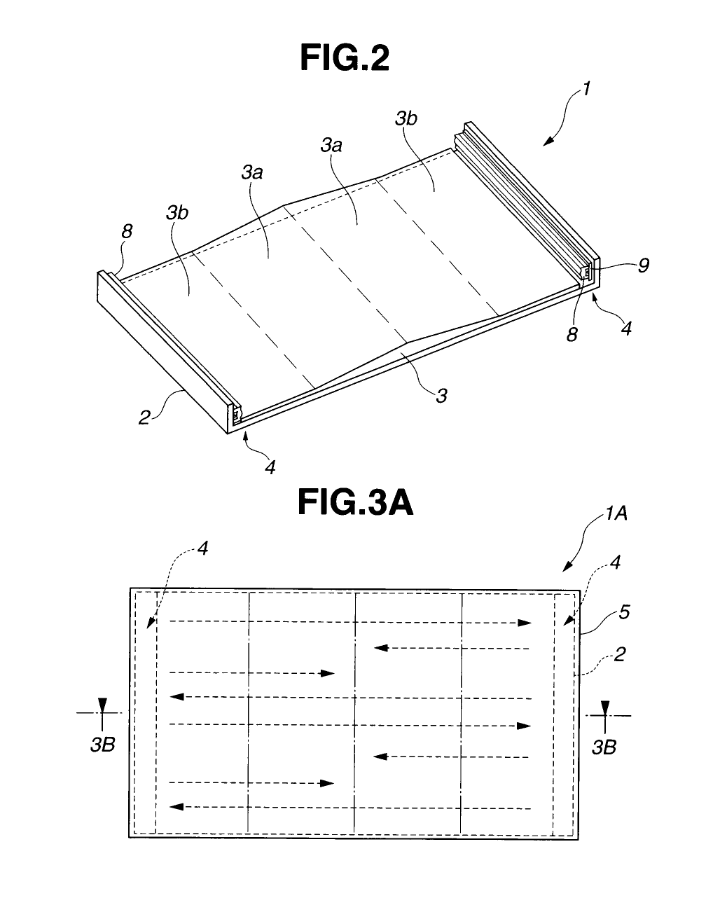

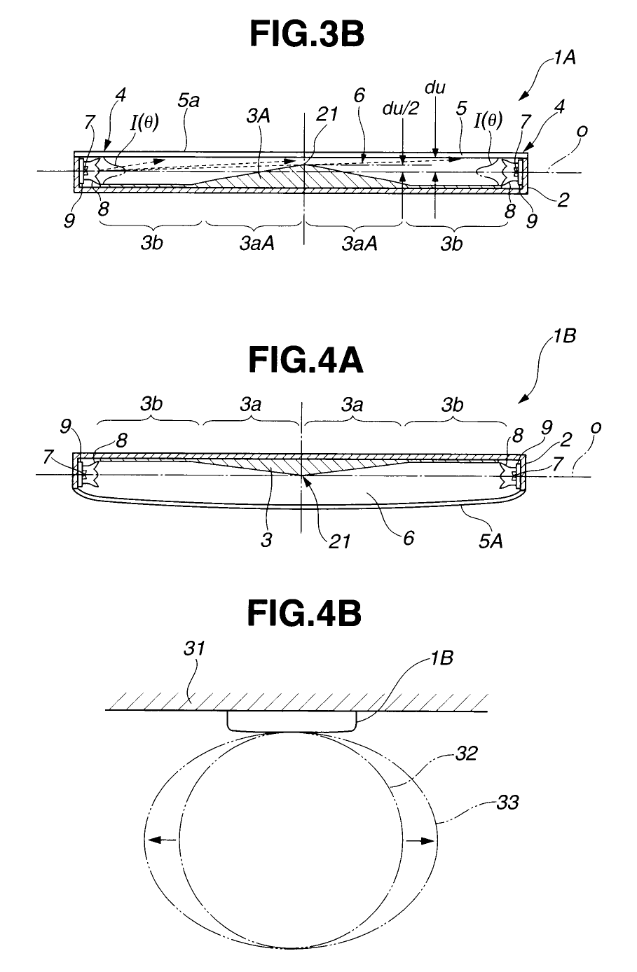

FIG. 2 is a partial perspective view for describing the shape of the reflection member 3. The reflection member 3 has a central convexly raised portion, two inclined surfaces 3a of the raised portion, and two level surfaces 3b extending from the skirts of the raised portion. Each of the two inclined surfaces 3a is inclined at a predetermined angle downward from a ridge line of the central raised portion toward the corresponding level surface 3b. Each of the two level surfaces 3b is a flat surface portion substantially parallel to the optical axis O in a cross section perpendicular thereto. “Substantially parallel to the optical axis O” includes being inclined to the optical axis O by ±1 degrees or smaller. It is noted that since FIGS. 1A, 1B, and 2 are schematic views for describing the configuration of the lighting apparatus 1 of the present embodiment in an understandable manner, the dimensions of each member in the drawings do not necessarily conform to the description of angles in the specification and that the present invention should not be construed as limited to illustrated specific forms (the same thing applies to FIG. 3A and the following figures).

As shown in FIG. 2, the surface of the reflection member 3 facing the hollow regions 6 has a raised portion with a central ridge line and two slopes gently tailed therefrom. The surface of the reflection member 3 facing the hollow regions 6 reflects light incident thereon. The inclined surfaces 3a and the level surfaces 3b reflect light incident thereon at different ratios between a specular reflection component and a diffuse reflection component. In the light reflected off the inclined surfaces 3a, the amount of specular reflection component is greater than the amount of diffuse reflection component, whereas in the light reflected off the level surfaces 3b, the amount of diffuse reflection component is greater than the amount of specular reflection component. The four surfaces, the two level surfaces 3b and the two inclined surfaces 3a, form a lower-side reflection surface. As shown in FIG. 1B, the two hollow regions 6 are formed between the lower-side reflection surface, which is formed of the inclined surfaces 3a and the level surfaces 3b, and the diffuser plate 5.

A more specific description will be made below.

Each of the level surfaces 3b is provided on the side where the corresponding light source 4 is present in a cross section perpendicular to the lighting surface 5a. That is, the two level surfaces 3b extend from the respective light sources 4 toward the center, as shown in FIG. 1B. The reflection surface of each of the level surfaces 3b is substantially parallel to the optical axis O. “Substantially parallel to the optical axis O” includes being inclined to the optical axis O by ±1 degrees or smaller, as described above.

The two inclined surfaces 3a are provided in a central portion of the reflection member 3 in a cross section perpendicular to the lighting surface 5a, as shown in FIG. 1B. Each of the inclined surfaces 3a has a linear or curved cross-sectional shape inclined to the optical axis O at a predetermined angle. The inclined surfaces 3a will be described by assuming that the cross-sectional shape thereof is formed of a straight line for ease of description in the present embodiment and variations thereof, which will be described later, but each of the inclined surfaces 3a may have a shape following a gentle square function, a gentle S-shaped function, or any other variety of functions.

Each of the light sources 4 is configured with a plurality of light emitting devices (LEDs 7 in the present embodiment) and a collimator lens 8. As shown in FIGS. 1A, 1B, and 2, each of the light sources 4 is a linear light source unit in which a plurality of LEDs 7 are arranged in a direction perpendicular to the optical axis O. In the light source 4, the LEDs 7 are mounted as a linear LED array on an elongated substrate 9 provided along an inner surface of a sidewall portion of the housing 2. The collimator lens 8 is an elongated member made of an acrylic resin, a polycarbonate resin, or any other suitable transparent resin, or glass and disposed in the vicinity of a light-exiting portion of the light source 4. In the present embodiment, the collimator lens 8 is a cylindrical lens having a total-reflection parabolic cross-sectional shape. The collimator lens 8 is an optical system configured to radiate the light emitted from each of the linearly arranged LEDs 7 toward the hollow region 6 as a beam having a narrow-angle light intensity distribution characteristic centered around the optical axis O. The narrow-angle light intensity distribution characteristic desirably corresponds to an intensity distribution that falls within ±15 degrees from the optical axis O of the light source 4 in the cross-sectional view of FIG. 1B.

The diffuser plate 5 has a flat surface that forms the lighting surface 5a parallel to the optical axis O of the light emitted from each of the light sources 4. Further, the diffuser plate 5, which is disposed in a position spaced apart from the optical axis O by a predetermined distance as shown in FIG. 1B, diffuses part of the light that originates from the pair of light sources 4 facing each other and directly impinges on the diffuser plate 5 to cause the lighting surface 5a to radiate light. The remainder of the light that originates from the light sources 4 and directly impinges on the diffuser plate 5 is reflected off the diffuser plate 5 and incident on the reflection member 3. Further, the reflected light of light that has originated from the light sources 4 and has directly impinged on the reflection member 3, and higher-order, multiple reflected lights inside the hollow cavity eventually pass through the diffuser plate 5 and cause the lighting surface 5a to radiate light. As described above, the diffuser plate 5 is a member that forms the lighting surface 5a, which diffuses and radiates light outward.

As described above, the lighting apparatus 1 includes the pair of light sources 4 facing each other, the reflection member 3, which forms the lower-side reflection surface, and the diffuser plate 5 with the lighting surface 5a. Reflection characteristics of the reflection member 3 determine the amount of reflection component of the light emitted from each of the light sources 4, and the amount of reflection component affects the luminance over the lighting surface 5a and the degree of uniformity of the luminance. That is, the lighting apparatus 1 is configured in such a way that the light emitted from each of the light sources 4 has a narrow intensity distribution and the reflection member 3 has a predetermined shape in order to increase the degree of uniformity over the lighting surface 5a. To increase the degree of uniformity of the luminance over the lighting surface 5a, the diffuser plate 5 may be illuminated through the hollow cavity in such a way that the illuminance distribution over the lower surface of the diffuser plate 5 is uniform.

An insufficiently narrow intensity distribution of the light from each of the light sources 4 results in a decrease in efficiency. From this reason, it is not appropriate to use a conventional light source as it is, such as a cold cathode fluorescent lamp, which has a wide light intensity distribution. To achieve a thin and uniform lighting apparatus 1, it is preferable to use solid-state light emitting devices, such as the LEDs 7 having a relatively narrow light intensity distribution characteristic, and a collimator optical system, such as the collimator lens 8.

Consider a reflection surface spaced apart from the light sources 4. In this case, the angle of incident of illumination light on the thus spaced-apart reflection surface decreases, and hence the illuminated area increases. When the illuminated area increases, the illuminance decreases accordingly. If the intensity distribution (profile) of the light emitted from each of the light sources 4 is controlled in such a way that the illuminated area of or the illuminance over a portion of the diffuser plate 5 and the reflection surface 3 per unit solid angle of the emitted light is constant, the degree of uniformity of the luminance over the lighting surface 5a increases. To this end, it is necessary to control the intensity distribution of the light from each of the light sources 4 to have a profile in which the intensity of the light becomes greater when the angle of the exiting light is shallower, that is, the angle θ with respect to the optical axis O is closer to zero degrees. That is, to illuminate a flat reflection surface that extends infinitely, a sharp light intensity distribution profile having an infinite amount of light at the center is required. Even when the flat surface has a finite length, it is difficult to achieve surface emission having a high degree of uniformity unless the light intensity distribution is sharp enough for the finite length.

To this end, a portion of the lower-side reflection surface 3 that is far away from each of the light sources 4 (that is, each of the inclined surfaces 3a) is formed to be inclined at a predetermined angle with respect to the optical axis O of the exiting light. This configuration allows the light intensity distribution profile of each of the light sources 4 to have an achievable half-value angle.

The above description will be further described below by using mathematical expressions.

Now, let an equation I(θ) be the light intensity distribution characteristic of each of the light sources 4 (see FIG. 1B). An illuminated area S of an infinite flat surface per very small unit solid angle Δθ is expressed by the following equation:

S=dΔθ/sin² θ Equation (1)

where d is a vertical distance (constant) from the optical axis O to the level surface 3b of the reflection member 3. In Equation (1), the length in the depth direction in FIG. 1B is a unit length.

In the light intensity distribution characteristic I(θ), the range from θ=90 degrees (that is, the direction perpendicular to the lighting surface) to θ=45 degrees is not very important because the distance is approximately only d. When the light intensity distribution characteristic I(θ) generally coincides with the shape of a function approximated by 1/sin² θ at least in a range from θ=45 degrees to approximately a half angle at half maximum of I(θ), the level surfaces 3b in this range are uniformly illuminated with the light emitted from the respective light sources 4.

Therefore, with the light intensity distribution characteristic of each of the light sources 4 expressed by a function approximated by 1/sin² θ in the range from 45 degrees with respect to the optical axis O to the half angle at half maximum, the reflection member 3 is formed in such a way that the level surfaces 3b fall within the range.

Further, it is difficult to achieve a light intensity distribution that can follow 1/sin² θ in a range from approximately the half angle at half maximum of the light intensity distribution characteristic I(θ) to θ=0 degrees (optical axis O), as described above. The reason for this is that a sharp light intensity distribution the center of which at the optical axis O extends infinitely cannot be achieved. Given the fact, the inclined surfaces 3a are provided in such a way that the reflection surface configured to receive exiting light within the range from approximately the half angle at half maximum of the light intensity distribution characteristic I(θ) to θ=0 degrees (optical axis O) is inclined so that the illuminance per very small unit solid angle Δθ is constant. That is, the reflection surface of each of the inclined surfaces 3a, which is configured to receive exiting light within the range from approximately the half angle at half maximum of the light intensity distribution characteristic I(θ) to θ=0 degrees (optical axis O) has an inclination angle according to an achievable light intensity distribution characteristic I(θ).

On the other hand, the diffuser plate 5 on the upper side is a flat plate that forms the lighting surface 5a. As described above, a portion of the lower surface of the diffuser plate 5 on which direct light from each of the light sources 4 is incident but which is located far away from the light source 4 has lower illuminance, and hence the degree of uniformity over the lighting surface 5a decreases.

It is conceivable to provide the diffuser plate 5 is provided with inclined surfaces, but the cost increases because it is necessary to prepare a dedicated diffuser plate which has not a typical flat surface. Further, variation in thickness of the lighting surface 5a itself or change in shape thereof makes it difficult to increase the degree of uniformity over the lighting surface. The diffuser plate 5 is therefore preferably a flat plate.

In the present embodiment, to compensate the decrease in illuminance in the portion far away from each of the light sources 4, a specular reflection component is added to a diffuse reflection component on the inclined surface 3a of the reflection member 3. That is, the portion of the inclined surface 3a that is far away from the light source 4 is configured to have an increased amount of specular reflection component. To achieve a uniform distribution over the lighting surface 5a, the inclination of the inclined surface 3a of the reflection member 3 is determined also considering the ratio between the diffuse reflection component and the specular reflection component described above.

For example, the reflection member 3 may have reflection characteristics that allow the amount of diffuse reflection component to be greater than the amount of specular reflection component on the level surfaces 3b and the amount of specular reflection component on the inclined surfaces 3a to gradually increase as the distance from the respective light sources 4 increases so that the amount of specular reflection component becomes greater than the amount of diffuse reflection component at some point. The ratio between the diffuse reflection component and the specular reflection component can be adjusted by changing the amount of metal deposition on the reflection surface or changing the degree of surface roughness as a function of position.

According to the planar lighting apparatus 1 with a hollow cavity described above, the thickness of the apparatus can be thin and the luminance on the lighting surface 5a can be uniformly distributed.

### Variations

A plurality of variations of the above first embodiment will next be described. In the following variations, the same components as those in the first embodiment described above have the same reference characters, and no description thereof will be made but different components will be primarily described.

### First Variation of First Embodiment

FIG. 3A is a plan view of a lighting apparatus 1A according to a first variation of the first embodiment of the present invention. FIG. 3B is a cross-sectional view taken along the line 3B-3B in FIG. 3A.

In the present variation, a reflection member 3A is formed in such a way that the height of a ridge line portion 21 where two inclined surface 3aA of the reflection member 3A come into contact with each other, that is, the distance from a bottom surface portion to the ridge line portion 21, is approximately equal to or greater than the distance from the bottom surface portion to the optical axis O. That is, the two inclined surface 3aA are disposed to intersect the optical axes O of the light sources 4.

When the light emitted from one of the pair of light sources 4 or primary specularly reflected light from one of the inclined surfaces 3aA is directly incident on the other opposing light source 4 or on the side surface portion of the housing 2 where the other opposing light source 4 is provided, the light emission efficiency decreases. The reason for this is that light absorption or stray light caused by the other light source 4 or the side surface portion also contributes to light loss.

To address the problem, in the lighting apparatus 1A of the present variation, the distance from the optical axis O to a ridge line connecting top portions of a raised portion of the reflection member 3A is at least one-half the distance du from the optical axis O to the diffuser plate 5, that is, at least du/2. As a result, part of the light emitted from each of the pair of light sources 4 may go beyond the ridge line portion 21, which is the top portion of the reflection member 3, but will not directly impinge on the opposing light source 4 or side surface portion, as shown in FIGS. 3A and 3B. Further, the reflection member 3A is formed in such a way that a space is created between the ridge line portion 21 and the diffuser plate 5.

That is, the ridge line portion 21, where the two inclined surface 3aA come into contact with each other, blocks the light from the pair of light sources 4 so that the light is not incident on the respective counterparts. As a result, the light from one of the light sources 4 is not directly incident on the other light source 4 or other components but illuminates the diffuser plate 5 including the vicinity of the other light source 4, whereby a more uniform illuminance distribution is provided over the lighting surface 5a.

The thus configured lighting apparatus 1A prevents the light emission efficiency from decreasing.

### Second Variation of First Embodiment

FIG. 4A is a cross-sectional view of a lighting apparatus 1B according to a second variation of the first embodiment of the present invention. FIG. 4B is a view for describing the light intensity distribution characteristic of the lighting apparatus 1B.

In the present variation, a diffuser plate 5A is shaped in such a way that a central portion convexly swells from hollow regions 6 toward the space outside the diffuser plate 5A (downward in FIG. 4A). In other words, the diffuser plate 5A is shaped in such a way that the central portion is convexly curved outward in a cross section perpendicular to the ridge line of the raised portion of the reflection member 3.

A diffuser plate having a flat surface as shown in FIG. 1B or 3B is desirably inexpensive, but when the lighting apparatus is used as an illuminating apparatus in a room in an office or a house, a user desires or tends to prefer a wide intensity distribution of the light from the illuminating apparatus.

To this end, in the lighting apparatus 1B of the present variation, the diffuser plate 5A is shaped in such a way that the central portion is convexly curved outward in a cross section perpendicular to the ridge line of the raised portion of the reflection member 3 so that the intensity distribution of the light emitted from the lighting surface spreads out, as shown in FIG. 4A.

As a result, as shown in FIG. 4B, the light intensity distribution characteristic of the lighting apparatus 1B attached to a ceiling 31 does not have a characteristic 32 corresponding to the case shown in FIG. 1B or 3B but has a characteristic 33 extending along the optical axis O. The lighting apparatus 1B is thus preferable as an illuminating apparatus.

### Third Variation of First Embodiment

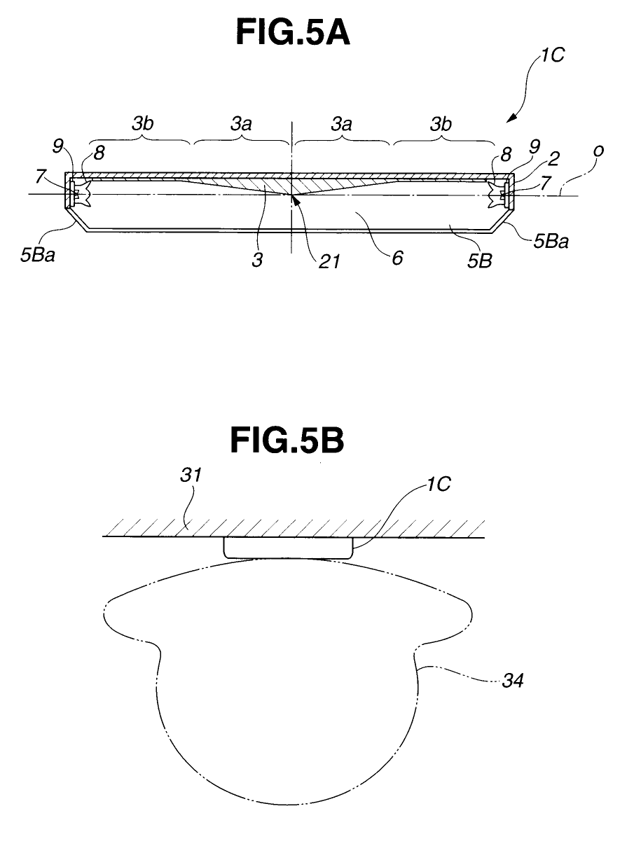

FIG. 5A is a cross-sectional view of a lighting apparatus 1C according to a third variation of the first embodiment of the present invention. FIG. 5B is a view for describing the light intensity distribution characteristic of the lighting apparatus 1C.

In the present variation, a diffuser plate 5B has a central flat plate and inclined corner portions 5Ba at both ends where the light sources 4 are located. That is, the diffuser plate 5B has a central portion extending in parallel to the optical axis O and end portions inclined to the optical axis O at a predetermined angle in a cross section perpendicular to the ridge line of the raised portion of the reflection member 3.

When the lighting apparatus 1C is used as an illuminating apparatus in a room in an office or a house, as in the lighting apparatus 1B according to the second variation, a user desires or tends to prefer a wide intensity distribution of light from the illuminating apparatus.

As shown in FIGS. 5A and 5B, since the diffuser plate 5B is generally shaped into a flat plate but has the corner portions 5Ba inclined at a predetermined angle at two end portions, the lighting apparatus 1C does not have the light intensity distribution characteristic shown in FIG. 1B or 3B but has a light intensity distribution characteristic 34, part of which extends along the optical axis O and forms skirt portions. The lighting apparatus 1C is thus preferable as an illuminating apparatus.

In the example described above, the corner portions 5Ba of the diffuser plate 5B are provided at the two end portions of the rectangular diffuser plate 5B, that is, along two sides thereof, but the corner portions 5Ba may alternatively be provided along four sides of the rectangular diffuser plate 5B.

### Fourth Variation of First Embodiment

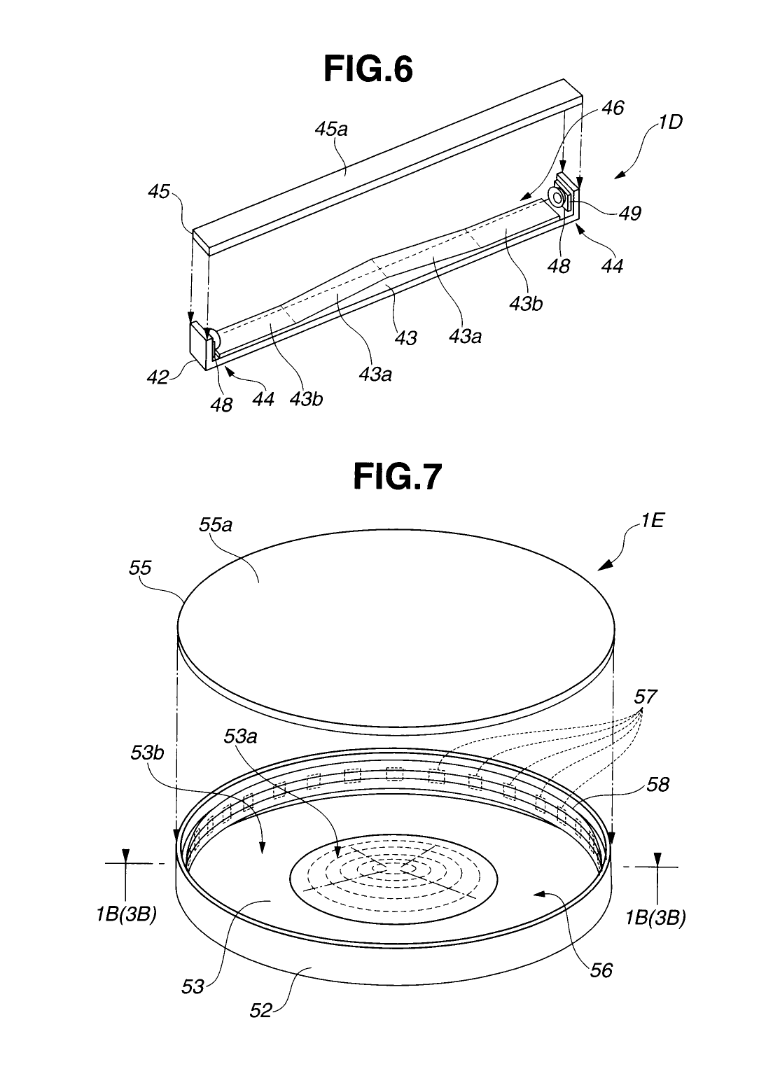

FIG. 6 is a partial perspective view for describing the configuration of a lighting apparatus 1D according to a fourth variation of the first embodiment of the present invention.

The lighting apparatus according to the embodiment and the variations thereof described above has a surface-emission lighting surface, whereas the lighting apparatus 1D of the present variation produces linear light emission from a lighting surface.

Two light sources 44 are provided inside side surface portions at both ends of an elongated housing 42. Each of the light sources 44 includes a light emitting device (not shown) provided on a substrate 49 and a lens-shaped collimator lens 48 disposed on the light-exiting side of the light emitting device. Each of the light sources 44 is a point light source unit formed of one LED and one typical collimator lens. In FIG. 6, longitudinal side surfaces of the housing 42 are omitted and not illustrated. An elongated plate-shaped diffuser plate 45 is provided on the upper side.

The cross-sectional shape of the lighting apparatus 1D taken along the optical axes of the light sources 44 is the same as that shown in FIG. 1B or 3B described above. In particular, a reflection member 43 has the same longitudinal cross-sectional shape as that of the reflection member 3 shown in FIG. 1B or the reflection member 3A shown in FIG. 3B described above. The housing 42, the reflection member 43, inclined surfaces 43a, level surfaces 43b, the diffuser plate 45, hollow regions 46, and the collimator lens 48 correspond to the housing 2, the reflection member 3, the inclined surfaces 3a, the level surfaces 3b, the diffuser plate 5, the hollow regions 6, and the collimator lens 8, respectively.

The lighting apparatus 1D has a generally thin plate shape, and an upper surface portion of the narrow-width diffuser plate 45 forms a lighting surface 45a, which produces linear light emission.

The lighting apparatus 1D of the present variation, which is a linear lighting apparatus with a hollow cavity, can also be thin and make the luminance distribution over the lighting surface 45a uniform. In particular, the lighting apparatus 1D of the present variation can be used, for example, as a light source of a scanner apparatus configured to scan an image.

### Fifth Variation of First Embodiment

FIG. 7 is a partial perspective view for describing the configuration of a lighting apparatus 1E according to a fifth variation of the first embodiment of the present invention.

Each of the lighting apparatus according to the embodiment and the variations thereof described above is a linear- or planar-emission lighting apparatus with a rectangular lighting surface, whereas the lighting apparatus 1E of the present variation is a lighting apparatus with a circular lighting surface.

A reflection member 53 having a cone-shaped portion is disposed in a central portion of a bottom surface of a housing 52 having a circular shape in a plan view. The reflection member 53 has a central inclined surface 53a and a peripheral, annular level surface 53b.

A plurality of LEDs 57, which are light emitting devices provided on a substrate (not shown), are provided all along an inner circumferential surface of a ring-shaped side surface portion of the housing 52 and emit light toward the central portion of the reflection member 53. In other words, the LEDs are provided to form a ring shape in such a way that the optical axes thereof intersect at a single point in a single plane, and each of the LEDs 57 emits light having a narrow-angle light intensity distribution characteristic toward the single point.

To this end, a ring-shaped collimator lens 58 is disposed on the inner circumferential side of the LEDs 57 so that the light emitted from each of the LEDs 57 is focused at the center of the housing 52.

A circular diffuser plate 55 is provided on the upper side of the housing 52, and a hollow region 56 is formed between the reflection member 53 and the diffuser plate 55.

Specifically, the diffuser plate 55 is a circular member disposed in a position spaced apart from the bottom surface of the housing 52 by a predetermined distance and has a lighting surface 55a parallel to the optical axes of the LEDs 57. The lighting surface 55a receives the light emitted from each of the LEDs 57 and diffuses and radiates the light outward.

The cross section of the lighting apparatus 1E taken along the line 1B-1B (3B-3B) in FIG. 7 is the same as that shown in FIG. 1B (or FIG. 3B) described above. The housing 52, the reflection member 53, the inclined surface 53a, the level surface 53b, the diffuser plate 55, the hollow region 56, the LEDs 57, and the collimator lens 58 correspond to the housing 2, the reflection member 3, the inclined surfaces 3a, the level surfaces 3b, the diffuser plate 5, the hollow regions 6, the LEDs 7, and the collimator lens 8, respectively.

Therefore, the lighting apparatus 1E of the present variation can also be a thin, planar lighting apparatus with a hollow cavity capable of making the luminance distribution over the circular lighting surface 55a uniform. The lighting apparatus 1E of the present variation can be used, for example, as a traffic light and a speedometer of an automobile as well as a circular illuminating apparatus for a typical office and house.

### Sixth Variation of First Embodiment

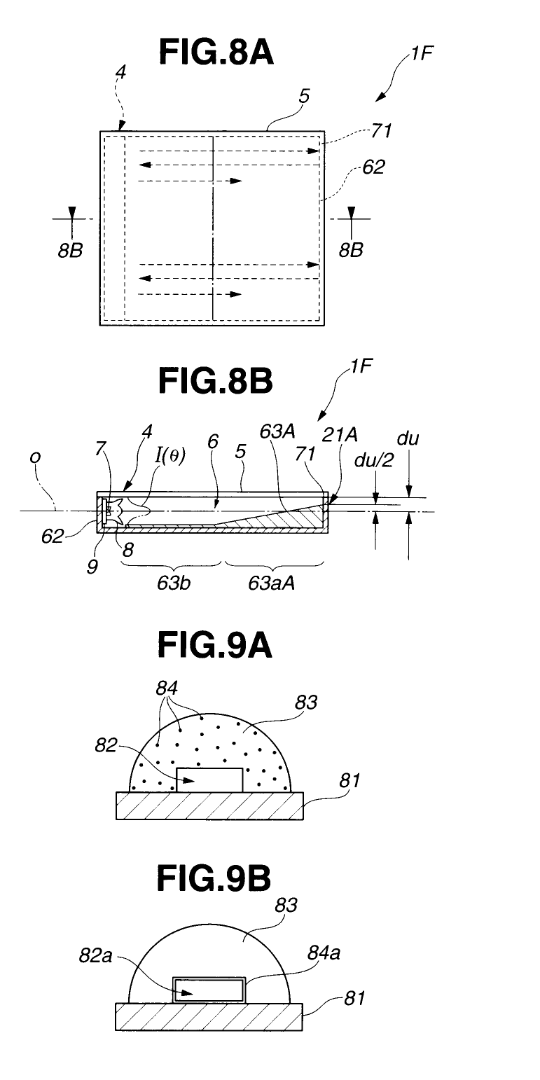

FIG. 8A is a plan view of a lighting apparatus 1F according to a sixth variation of the first embodiment of the present invention. FIG. 8B is a cross-sectional view taken along the line 8B-8B in FIG. 8A.

In the present variation, a light source array 4 is provided inside one side surface portion of a box-shaped housing 62, and a reflection mirror 71 is provided inside the corresponding opposing side surface portion and above an end portion 21A of a reflection member 63A. The reflection mirror 71 has a mirror surface facing the interior of the lighting apparatus.

Specifically, in the present variation as well, the reflection member 63A has an inclined surface 63aA configured to gradually go upward from a level surface 63b toward the reflection mirror 71. The reflection member 63A is formed in such a way that the height of the end portion 21A of the reflection member 63A on the side where the inclined surface 63aA is present, that is, the distance from a bottom surface portion to the end portion 21A, is greater than or equal to the distance from the bottom surface portion to the optical axis O. In the present variation, the end portion 21A of the reflection member 63A on the side where the inclined surface 63aA is present is at least one-half the distance du from the optical axis O to the diffuser plate 5.

As shown in FIGS. 8A and 8B, in the lighting apparatus 1F, the light source 4 is disposed only on one side and no light source is present on the opposite side that faces the one side. Instead, the reflection mirror 71 is disposed above the end portion 21A of the inclined surface 63 on the opposite side. The reflection mirror 71 is provided on the side surface portion facing the side surface portion on which the light source 4 is provided, more specifically, on a flat surface of the side surface portion that is perpendicular to the flat surface of the diffuser plate 5 and parallel to the light source array 4.

The reflection mirror 71 is disposed between the end portion 21A and the diffuser plate 5, and the thus disposed reflection mirror 71 forms a mirror image configuration corresponding to the configuration shown in FIG. 3B. As a result, the light having impinged on the reflection mirror 71 will not directly return to the light source 4 but impinges on the diffuser plate 5, whereby light loss can be suppressed.

According to the present variation, an efficient, planar lighting apparatus can be provided.

The lighting apparatus 1F of the present variation has been described with reference to the case where surface light emission is produced from the lighting surface, but the light emission from the lighting surface may alternatively be linear emission as shown in FIG. 6.

### Second Embodiment

A second embodiment will next be described. In the description of the second embodiment, the components that are the same as or corresponding to those in the first embodiment described above have the same reference characters.

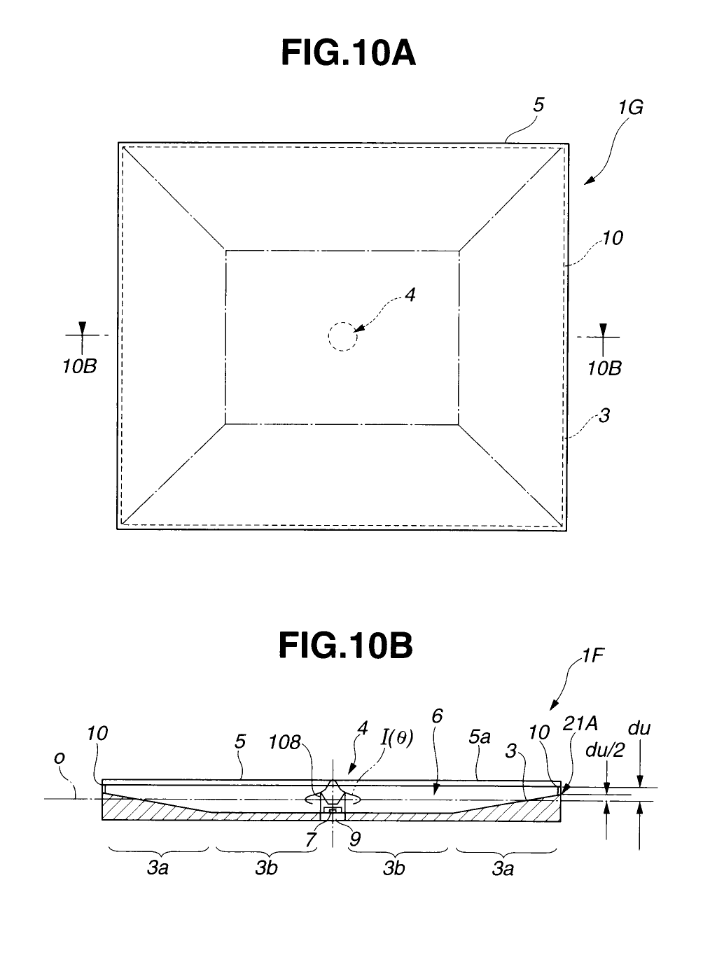

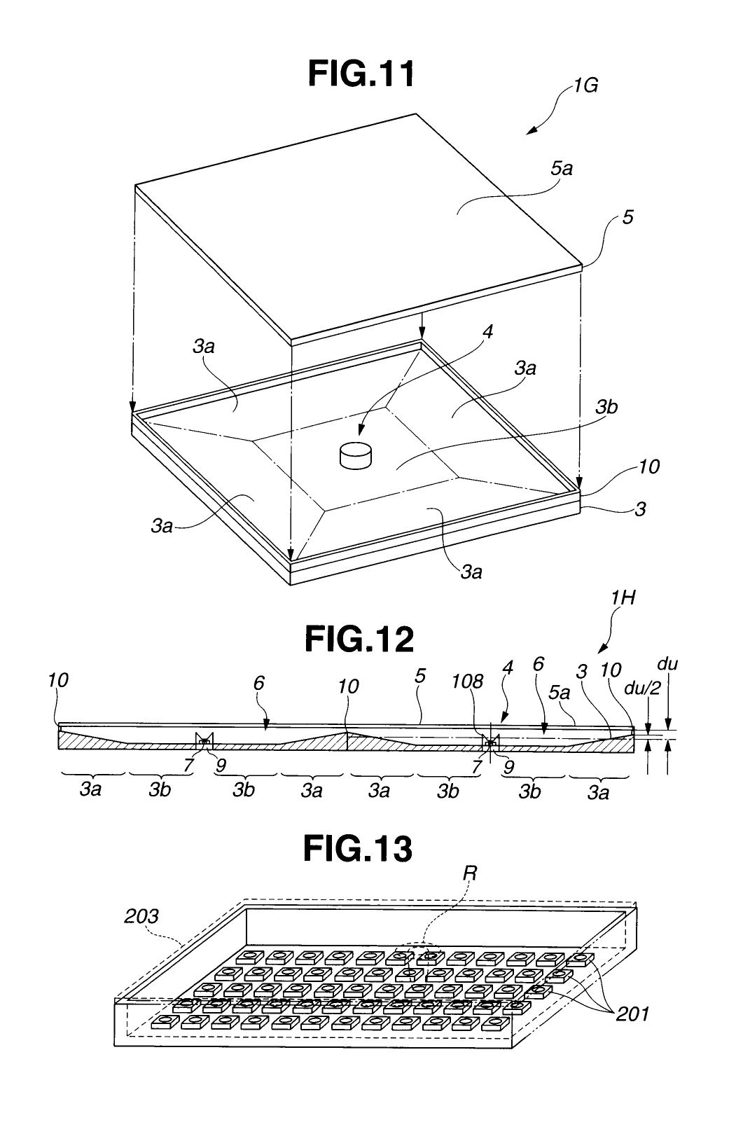

FIG. 10A is a plan view of a lighting apparatus 1G according to the second embodiment of the present invention. FIG. 10B is a cross-sectional view taken along the line 10B-10B in FIG. 10A. FIG. 11 is a partial perspective view for describing the shape of a reflection member of the lighting apparatus according to the second embodiment of the present invention.

The lighting apparatus 1G shown in FIGS. 10A and 10B is a flat panel with a hollow cavity, specifically, a flat LED lighting panel (FL²P), and includes a rectangular lighting surface. The lighting apparatus 1G includes a reflection member 3, a light source 4, and a diffuser plate 5.

The reflection member 3 has a rectangular shape in a plan view viewed from the side where the diffuser plate 5 is present and has four peripheral inclined surfaces 3a and a central level surface 3b surrounded by the four inclined surfaces 3a. The reflection member 3 is disposed on the bottom side of the lighting apparatus 1G. The light source 4 is disposed in a central portion of the level surface 3b when the lighting apparatus 1G is viewed from the above. A hollow region 6 is formed between the reflection member 3 and the diffuser plate 5.

The lighting apparatus 1G has a generally thin box shape and emits light from a lighting surface 5a, which is an upper-side surface of the diffuser plate 5.

The light source 4 includes an LED 7, which is a single light emitting device, and an optical member 108 configured to radially output the light from the LED 7 so that the light spreads in a plane parallel to the diffuser plate 5. The optical member 108 is a light intensity distribution transverse conversion collimator optical system. The LED 7 and the optical member 108 are provided on a substrate 9 in such a way that the LED 7 is located in a position corresponding to the center of the optical member 108. The number of LED 7, which emits light toward the optical member 108, is not necessarily one but may be two or more.

As shown in FIGS. 10B and 11, the reflection member 3 has a lowered central portion, and the inner shape of a cross section of the reflection member 3 taken along a plane perpendicular to the lighting surface 5a is a trapezoid. As shown in FIG. 11, the reflection member 3 has the rectangular central level surface 3b, on which the light source 4 is disposed, and the four inclined surfaces 3a surrounding the level surface 3b on the side facing the diffuser plate 5.

Each of the four inclined surfaces 3a is inclined in such a way that it starts from the corresponding one of the four sides of the level surface 3b and approaches the diffuser plate 5 toward a peripheral portion of the reflection member 3. The level surface 3b is a flat surface substantially parallel to a plane O containing the optical axes of the light fluxes emitted from the light source 4 (hereinafter also referred to as an optical axis plane). “Substantially parallel to the optical axis plane O” includes being inclined to the optical axis plane O by ±1 degrees or smaller. It is noted that since FIGS. 10A, 10B, and 11 are schematic views for describing the configuration of the lighting apparatus 1G of the present embodiment in an understandable manner, the dimensions of each member in each of the drawings do not necessarily conform to the description of angles in the specification and that the present invention should not be construed as limited to illustrated specific forms (the same thing also applies to FIG. 12 and the following figures).

As shown in FIG. 11, the reflection member 3 has the central level surface 3b. The level surface 3b and the four inclined surfaces 3a surrounding the level surface 3b are continuously connected to each other. The single level surface 3b and the four inclined surfaces 3a form a lower-side reflection surface. The hollow region 6 is formed between the lower-side reflection surface and the diffuser plate 5.

A reflection mirror 10 with a mirror surface is provided along an outer side portion of each of the inclined surfaces 3a in the area between a highest peripheral portion 21A, that is, a portion 21A of the inclined surface 3a that is positioned closest to the diffuser plate 5, and the diffuser plate 5.

A more specific description will be made below.

The reflection member 3 has a reflection surface facing the diffuser plate 5 and reflecting the light emitted from the light source 4, and the hollow region 6 is formed between the reflection surface and the diffuser plate 5.

In the light source 4, the LED 7 as a light emitting device emits light, and the optical member 108, which is a light intensity distribution transverse conversion collimator optical system, converts the light into light having a narrow-angle light intensity distribution characteristic centered around the optical axis plane O parallel to the diffuser plate 5 and radially outputs the converted light. To this end, the optical member 108, which is a light intensity distribution transverse conversion collimator optical system configured to convert a light intensity distribution, is provided above the LED 7 in the light source 4 so that a large portion of light intensity distribution components of the light from the LED 7, which emits light upward, is radially outputted in the transverse direction in FIG. 10B. The narrow-angle light intensity distribution characteristic desirably falls within ±15 degrees with respect to the optical axis of the light source 4 in the cross-sectional view of FIG. 10B.

As shown in FIGS. 10B and 11, the level surface 3b is provided in the vicinity of the light source 4 so that the illuminance distribution over the lighting surface 5a is uniform in a cross section perpendicular to the lighting surface 5a. The reflection surface of the level surface 3b is substantially parallel to the optical axis plane O. “Substantially parallel to the optical axis plane O” includes being inclined to the optical axis plane O by ±1 degrees or smaller, as described above.

The inclined surfaces 3a of the reflection member 3 is formed around the level surface 3b, as shown in FIGS. 10B and 11, and each of the inclined surfaces 3a is formed of straight or curved lines inclined to the optical axis plane O at a predetermined angle when viewed in a cross-sectional view. The inclined surfaces 3a will be described by assuming that the cross-sectional shape thereof is formed of a straight line for ease of description in the present embodiment and variations thereof, which will be described later, but each of the inclined surfaces 3a may have a shape following a gentle square function, a gentle S-shape function, or any other variety of functions.

The diffuser plate 5 has the lighting surface 5a parallel to the optical axis plane O. Further, the diffuser plate 5 is a member spaced apart from the optical axis plane O by a predetermined distance and forming the lighting surface 5a configured to receive the light in the hollow cavity and diffuse and radiate the light, as shown in FIG. 10B.

As described above, the lighting apparatus 1G includes the light source 4, the reflection member 3, which forms the lower-side reflection surface, and the diffuser plate 5 with the lighting surface 5a. To make the lighting apparatus 1G thin and uniform, the light source 4 used herein has a narrow-angle light intensity distribution characteristic. Reflection characteristics of the reflection member 3 determine the amount of reflection component of the light emitted from the light source 4, and the amount of reflection component then affects the luminance over the lighting surface 5a and the degree of uniformity of the luminance. That is, the lighting apparatus 1G is configured in such a way that the light emitted from the light source 4 has a narrow intensity distribution and the reflection member 3 has a predetermined shape in order to increase the degree of uniformity of the luminance over the lighting surface 5a. To increase the degree of uniformity over the lighting surface 5a, the diffuser plate 5 may be illuminated through the hollow cavity in such a way that the illuminance distribution over the lower surface of the diffuser plate 5 is uniform.

Consider a reflection surface spaced apart from the light source 4. In this case, the angle of incident of illumination light on the thus spaced-apart reflection surface decreases, and hence the illuminated area increases. When the illuminated area increases, the illuminance decreases accordingly. If the intensity distribution (profile) of the light emitted from the light source 4 is controlled in such a way that the illuminated area of or the illuminance over a portion of the diffuser plate 5 and the reflection surface per unit solid angle of the emitted light is constant, the degree of uniformity of the luminance over the lighting surface increases. To this end, it is necessary to control the intensity distribution of the light from the light source 4 to have a profile in which the intensity of the light becomes greater when the angle of the exiting light is shallower, that is, the angle θ with respect to the optical axis or optical axis plane O is closer to zero degrees. That is, to illuminate a flat reflection surface that extends infinitely, a sharp light intensity distribution profile having an infinite amount of light at the center is required. Even when the flat surface has a finite length, it is difficult to achieve surface emission having a high degree of uniformity unless the light intensity distribution is sharp enough for the finite length. To this end, a portion of the lower-side reflection surface 3 that is far away from the light source 4 (that is, each of the inclined surfaces 3a) is formed to be inclined at a predetermined angle with respect to the optical axis or optical axis plane O of the exiting light. This configuration allows the light intensity distribution profile of the light source 4 to have an achievable half-value angle.

The above description will be further described below by using mathematical expressions.

Now, let an equation I(θ) be the light intensity distribution characteristic of the light source 4 (see FIG. 10B). An illuminated area S of an infinite flat surface per very small unit solid angle Δθ is expressed by the following equation:

S=dΔθ/sin² θ Equation (2)

where d is a vertical distance (constant) from the optical axis plane O to the level surface 3b of the reflection member 3. In Equation (2), the length in the depth direction in FIG. 10B is a unit length.

In the light intensity distribution characteristic I(θ), the range from θ=90 degrees (that is, the direction perpendicular to the lighting surface) to θ=45 degrees is not very important because the distance is approximately only d. When the light intensity distribution characteristic I(θ) generally coincides with the shape of a function approximated by 1/sin² θ at least in a range from θ=45 degrees to approximately a half angle at half maximum of I(θ), the level surface 3b in this range is uniformly illuminated with the light from the light source 4.

Therefore, with the light intensity distribution characteristic of the light source 4 expressed by a function approximated by 1/sin² θ in the range from 45 degrees with respect to the optical axis plane O to the half angle at half maximum, the reflection member 3 is formed in such a way that the level surface 3b falls within the range.

Further, it is difficult to achieve a light intensity distribution that can follow 1/sin² θ in a range from approximately the half angle at half maximum of the light intensity distribution characteristic I(θ) to θ=0 degrees (optical axis), as described above. The reason for this is that a sharp light intensity distribution the profile of which at the center of the optical axis plane O extends infinitely cannot be achieved. Given the fact, the inclined surfaces 3a are provided in such a way that the reflection surface configured to receive exiting light within the range from approximately the half angle at half maximum of the light intensity distribution characteristic I(θ) to θ=0 degrees (optical axis plane O) is inclined so that the illuminance per very small unit solid angle Δθ is constant. That is, the reflection surface of each of the inclined surfaces 3a, which is configured to receive exiting light within the range from approximately the half angle at half maximum of the light intensity distribution characteristic I(θ) to θ=0 degrees, has an inclination angle according to an achievable light intensity distribution characteristic I(θ).

On the other hand, the diffuser plate 5 on the upper side is a flat plate that forms the lighting surface 5a. As described above, a portion of the lower surface of the diffuser plate 5 on which direct light from the light source 4 is incident but which is far away from the light source 4 has lower illuminance, and hence the degree of uniformity over the lighting surface 5a decreases.

It is conceivable to provide the diffuser plate 5 with inclined surfaces, but the cost increases because it is necessary to prepare a dedicated diffuser plate which has not a typical flat surface. Further, variation in thickness of the lighting surface 5a itself or change in shape thereof makes it difficult to increase the degree of uniformity over the lighting surface. The diffuser plate 5 is therefore preferably a flat plate.

In the present embodiment, to compensate the decrease in illuminance in the portion far away from the light source 4, a specular reflection component is added to a diffuse reflection component on the inclined surfaces 3a of the reflection member 3. That is, the portion of each of the inclined surfaces 3a that is far away from the light source 4 is configured to have an increased amount of specular reflection component. To achieve a uniform distribution over the lighting surface 5a, the inclination of the inclined surface 3a of the reflection member 3 is determined also considering the ratio between the diffuse reflection component and the specular reflection component described above.

For example, the reflection member 3 may have reflection characteristics that allow the amount of diffuse reflection component to be greater than the amount of specular reflection component on the level surface 3b and the amount of specular reflection component on the inclined surfaces 3a to gradually increase as the distance from the light source 4 increases so that the amount of specular reflection component becomes greater than the amount of diffuse reflection component at some point. The ratio between the diffuse reflection component and the specular reflection component can be adjusted by changing the amount of metal deposition on the reflection surface or changing the degree of surface roughness as a function of position.

According to the planar lighting apparatus 1G with a hollow cavity described above, the thickness of the apparatus can be thin and the luminance distribution over the lighting surface 5a can be uniform.

### Variations

A plurality of variations of the above second embodiment will next be described. In the following variations, the same components as those in the second embodiment described above have the same reference characters, and no description thereof will be made but different components will be primarily described.

### First Variation of Second Embodiment

FIG. 12 is a cross-sectional view of a lighting apparatus 1H according to a first variation of the second embodiment of the present invention.

The lighting apparatus 1H of the present variation has a larger lighting surface by arranging a plurality of lighting apparatus 1G according to the second embodiment described above in a 2×2 two-dimensional matrix. Four lighting apparatus 1G are provided in such a way that the lighting surfaces 5a are arranged in a single flat plane and connected to each other. FIG. 12 is a cross-sectional view of two of the thus arranged lighting apparatus 1G. The lighting apparatus 1H includes a plurality of lighting apparatus 1G, each of which works as a reflective flat LED local lighting panel (FL³P) with a hollow cavity.

In the lighting apparatus 1H of the present variation, a plurality of lighting apparatus 1G of the second embodiment described above are connected seamlessly, like tiling, to form a surface lighting apparatus having a larger lighting surface.

The lighting apparatus 1H can have a larger lighting surface by arranging a plurality of lighting apparatus 1G in a matrix because in each of the lighting apparatus 1G, the light source 4 is positioned at the center and the reflection mirrors 10 of the inclined surfaces 3a are positioned along outer side portions.

In particular, since each of the reflection mirrors 10 blocks leakage light from leaking to adjacent lighting apparatus 1G, the lighting apparatus 1H shows a highly advantageous effect when the lighting apparatus 1H is used in a local area dimming backlight apparatus.

An example of local area dimming in a backlight apparatus using a direct method will now be described.

A local area dimming backlight apparatus has been developed to compensate a disadvantage of poor contrast of a liquid crystal display apparatus (hereinafter referred to as LCD) and control power consumption thereof.

In an LCD, a backlight source is fully turned on even in a black-display state. Additionally, since the transmittance of the liquid crystal molecules will not be zero even in the black-display state, backlight from the fully turned-on backlight source disadvantageously leaks through the liquid crystal molecules.

The contrast is therefore limited to approximately 1000:1 at the maximum. Since human eyes recognize the contrast in a logarithmical manner, the contrast at this level is insufficient. Further, since the backlight source is fully turned on, the electric power cannot be reduced even in the black-display state. That is, the electric power is wasted.

Basically, local area dimming is a control operation characteristic of a backlight apparatus having LEDs arranged in a two-dimensional array. That is, the contrast is increased by dimming a portion (local area) corresponding to a dark video signal gray-scale stepwise. In this way, the contrast can be drastically improved approximately to 1000,000:1. Further, the power consumption can be significantly reduced accordingly, although it depends on how many pixels have dark values. The local area dimming technique is not applicable to a backlight apparatus using a long cold cathode fluorescent lamp (CCFL) but can be implemented in a backlight apparatus using LEDs.

For example, since a sufficiently advantageous effect is provided even when a local area (hereinafter also simply referred to as an “area”) is larger than a video signal, the backlight screen is divided into approximately 100 to 500 areas. It is then important to determine how much light is diffused, that is, allowed to leak from each of the thus divided areas into adjacent areas in order to obtain high-quality video images.

When the boundary between adjacent areas is too visible, the boundary does not match the boundary in actual video images. That is, an originally bright portion is displayed dark or an originally dark portion is displayed bright, resulting in unnatural video images. When light leaks beyond an adjacent area and enters the farther area, the video images are hazed, resulting in decrease in contrast. That is, it is necessary to make an adjustment in such a way that light naturally diffuses into adjacent areas as well as across the area of interest. On the other hand, when the backlight source is fully turned on, it is necessary to ensure uniformity across the area of interest and adjacent regions. As described above, the light diffusion control in the local area dimming is a very delicate task.

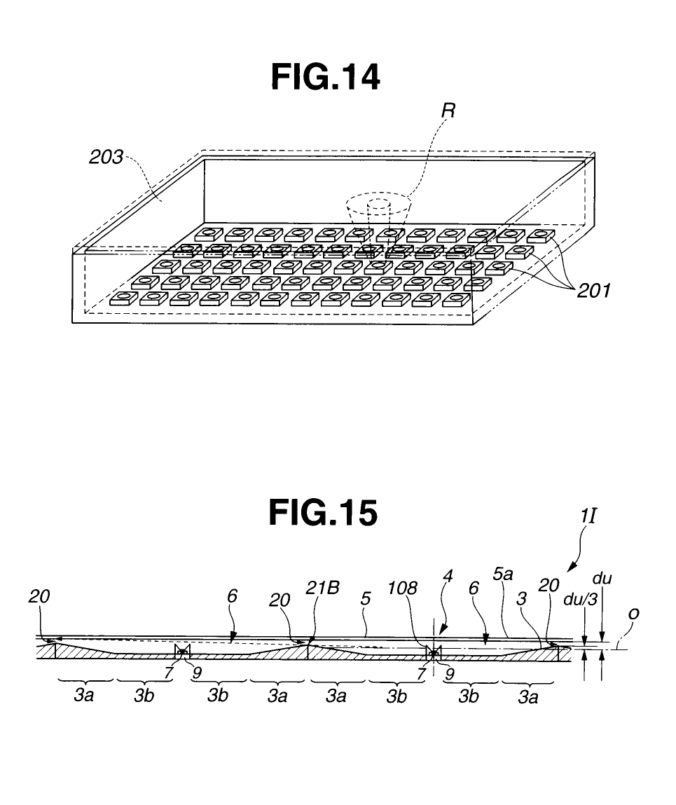

FIGS. 13 and 14 are views for describing examples of local area dimming by using LEDs 201 arranged in a two-dimensional array in accordance with a direct method of related art. In the direct method, a plurality of LEDs 201 are arranged in a matrix on a substrate in a bottom surface portion. In practice, a plurality of the LEDs 201 in a single area are driven together, whereas the following description will be made with reference to a case where one LED 201 corresponds to one area for ease of description. Light diffusion into adjacent areas is determined by the light intensity distribution of the LED itself and the height to the diffuser plate 203. As shown in FIG. 13, when the height to the diffuser plate 203 is small and hence a range R illuminated with light from each of the LEDs 201 is narrow, the LEDs 201, each of which is a point source, appear to be granular, resulting in degradation in uniformity when the LEDs are fully turned on.

To avoid the situation described above, it is necessary to increase the entire thickness so that the distance to the diffuser plate 203 increases, as shown in FIG. 14. When the height to the diffuser plate 203 is too large, however, a light intensity distribution component in the transverse direction of each of the LEDs reaches an area far away therefrom, resulting in decrease in contrast of video images.

In a local area dimming backlight apparatus of related art, it is therefore difficult to naturally diffuse light into a desired adjacent region of the diffuser plate in accordance with a local area dimming operation while maintaining a satisfactory light intensity distribution characteristic of the light source formed of the LEDs 201 and a small thickness of the entire apparatus.

In contrast, according to the lighting apparatus 1H having a plurality of lighting apparatus 1G arranged in a tiling manner, the following advantages are provided as shown in FIG. 12: The lighting surface 5a is large; the entire apparatus is thinner and lighter than an apparatus of relate art; and local area dimming is readily performed.

FIG. 12 shows a case where a 2×2 matrix is employed, but an m×n matrix (m and n are integers greater than or equal to two) may be employed.

### Second Variation of Second Embodiment

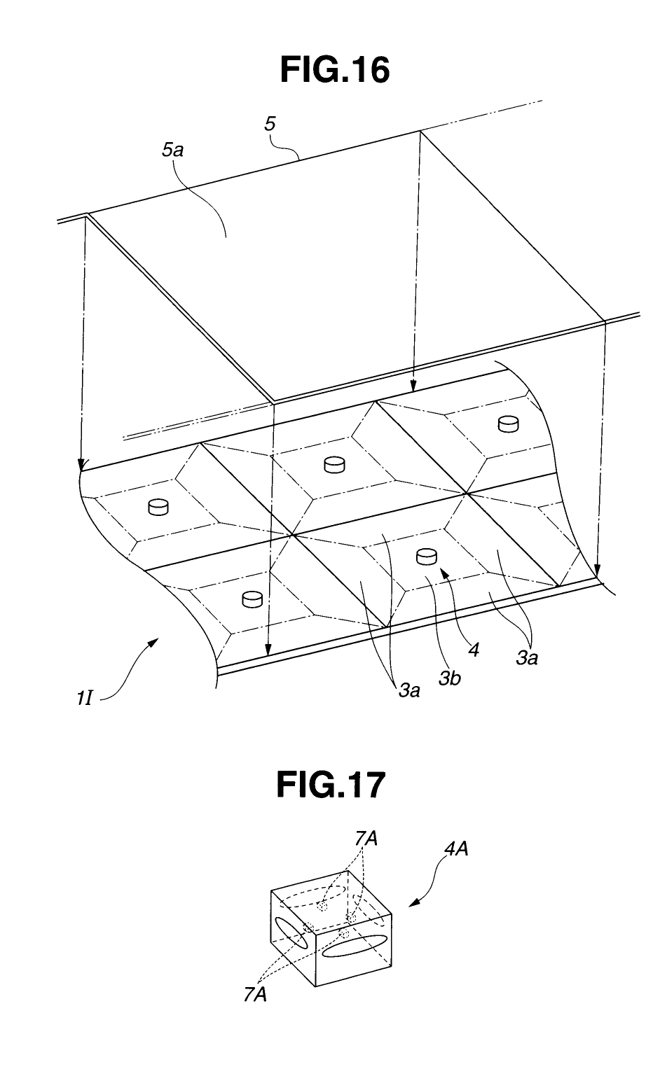

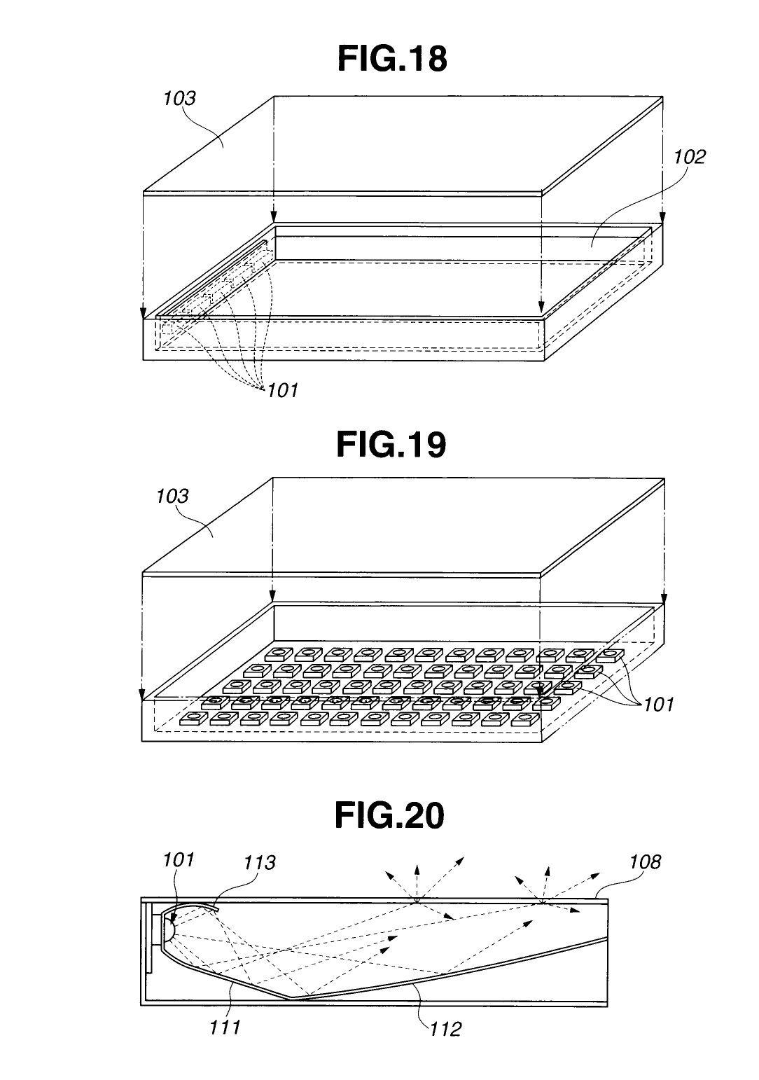

FIG. 15 is a cross-sectional view of a lighting apparatus 1I according to a second variation of the second embodiment of the present invention. FIG. 16 is a partial perspective view of the lighting apparatus 1I.

The lighting apparatus 1I of the present variation is configured in such a way that the reflection mirrors 10 in the first variation are removed and a predetermined space is created between a plurality of connected lighting apparatus 1G so that the hollow regions 6 in the lighting apparatus 1G communicate with each other.

In FIGS. 10B, 12, and 15, the inclined surfaces 3a and the level surface 3b have substantially the same cross-sectional shapes as those of the inclined surfaces 63aA and the level surface 63b in FIG. 8B showing the first embodiment.

In the lighting apparatus 1H of the first variation, the reflection mirror 10 present at the boundary between the lighting apparatus 1G may produce streaks in the diffuser plates 5 in some cases. In the second variation, however, the reflection mirror 10 is replaced with a window portion 20 as a predetermined space.

The window portion 20, which forms a predetermined space between the lighting apparatus 1G, not only prevents the streaks described above from being produced but also allows any leakage or diffusion of light into the lighting apparatus 1G that form an adjacent area to be controlled in accordance with the size of the window portion 20. This advantageous effect is particularly effective for the local area dimming backlight apparatus described above.

The size of the window portion 20 is determined by the highest position of the reflection member 3, that is, a portion (hereinafter referred to as a highest peripheral portion) 21B that is positioned closest to the diffuser plate 5. When the highest peripheral portion 21B is located in a position facing the diffuser plate 5 but away from the optical axis plane O by at least one-third the distance du between the optical axis plane O and the diffuser plate, direct light from the light source 4 is blocked by a raised portion of the highest peripheral portion 21B at the boundary between two adjacent lighting apparatus 1G and will hence not travel beyond the adjacent areas or reach other adjacent areas.

As described above, the advantageous effect of the window portion 20 can be generally controlled by the highest peripheral portion 21B of the raised portion of each of the inclined surfaces 3a. The light diffusion profile over the surface of the diffuser plate 5 can be more finely adjusted by the profile of a function representing the inclination of the inclined surface 3a of the reflection member 3, the ratio between the specular reflection component and the diffuse reflection component, and the intensity distribution of the light from the light source 4.

In a local area dimming backlight apparatus, in particular, each light source 4 is independently driven, and the amount of light is controlled for each area. When the light sources 4 are fully turned on, the degree of uniformity over a backlight surface formed of the connected lighting apparatuses 1G increases as a result of the inter-light diffusion through the window portions 20. In this case, the position of the highest peripheral portion 21B of each of the inclined surfaces 3a, the profile of the function representing the inclination of the reflection member 3, the ratio between the specular reflection component and the diffuse reflection component, and the intensity distribution of the light from each of the light sources 4 are also adjusted considering the result of the inter-diffusion.

### Third Variation of Second Embodiment

FIG. 17 is a diagrammatic perspective view of a light source 4A according to a third variation of the second embodiment of the present invention.

The light source 4 in each of the lighting apparatus 1G, 1H, and 1I according to the second embodiment and the variations thereof described above is configured in such a way that the LED 7 is covered with the optical member 108, which is a light intensity distribution transverse conversion collimator optical system, which converts a large portion of the light intensity distribution component of the light from the LED 7, which emits light upward, into light oriented in the transverse direction, that is, in the direction parallel to the diffuser plate 5.

In contrast, the light source 4A in the present variation is formed of four side-view-type LEDs 7A. According to the present variation, the light source 4A, although the necessary number of LEDs is greater than one, does not require the optical system of the sort described above.

### Other Variations

FIGS. 9A and 9B are views for describing variations of the light source.

The first and second embodiments and the variations thereof described above have been described with reference to the case where an LED is used as the light source. When a white light LED using a phosphor is used, the phosphor is distributed throughout a transparent resin in an LED package in some cases.

FIG. 9A is a cross-sectional view showing the configuration of an LED having a phosphor distributed throughout a resin. An LED chip 82 provided on a substrate 81 is covered with a transparent resin 83. The transparent resin 83 contains a phosphor 84 throughout the interior thereof.

When the phosphor is distributed throughout the transparent resin in the LED package, the light emitted from the LED package cannot be regarded as a point light source. As a result, when a collimator lens or any other optical system is used, it is in some cases necessary to produce chromatic aberrations or enlarge the lens, which makes it difficult to achieve an intended advantageous effect of the present invention.

For example, when the LED chip 82 is a blue LED and the phosphor 84 is a yellow phosphor (YAG, for example), two emitted light fluxes are combined to produce pseudo-white light. In this case, the blue LED chip 82, which is nearly a point light source, and the yellow phosphor 84 widely distributed in the transparent resin 83 cause spatial color separation in the light outputted through the optical system. That is, the color separation due to a mismatching between the sizes of the light emission regions causes periodic stripe-like yellow and blue color unevenness repeated at a long cycle on an illuminated flat surface.

To eliminate the color unevenness described above, the light source LED package is preferably configured as shown in FIG. 9B.

In the LED package shown in FIG. 9B, an LED chip 82a has a phosphor 84 coated on the surface of the LED chip, and the transparent resin 83 covers the LED chip 82a. The surface of the thus configured LED chip 82a is coated with the phosphor 84a in a conformal phosphor coating process.

That is, the LED chip 82a as the light emitting device in the light source 4 has the phosphor 84 provided on the surface of the LED chip 82a, and the transparent resin 83 is provided on the phosphor 84 to cover both the LED chip 82a and the phosphor 84a.

Using the thus configured LED package prevents color separation even when the light emitted from the LED package passes through an optical system, because the color of the light from the LED chip 82a itself is mixed with the color of the light from the phosphor 84a in the same position. As a result, a very small, chip-sized white light source is provided. Since the light from the light source can be converted through a small collimator lens into light having a narrow light intensity distribution, the lighting apparatus of the first and second embodiments and the variations thereof described above can be thin without any chromatic unevenness.

In the LED package described above, the phosphor 84a is provided on the surface of the LED chip 82a. The phosphor 84a is not necessarily provided on the surface of the LED chip 82a but may alternatively be provided in the close vicinity thereof.

Each of the lighting apparatus of the embodiments and the variations thereof described above is an apparatus having a uniform luminance distribution over the lighting surface. For example, each of the lighting apparatus can be used in a typical illuminating apparatus as well as in a backlight apparatus having a high degree of uniformity over the lighting surface.

The light source is not limited to a single-color LED but may alternatively be formed of a plurality of RGB LEDs or other color LEDs alternately arranged.

Further, in the embodiments and the variations thereof described above, an LED is used as the light emitting device in the light source, but a laser diode (LD) or any other suitable device may alternatively be used.

The principle described in the embodiments and the variations thereof described above can be used to achieve a lighting apparatus having a uniform luminance distribution over a lighting surface. That is, a uniform luminance distribution can be achieved by adjusting the inclination of a reflection plate, the ratio between a specular reflection component and a diffuse reflection component, the light intensity distribution of each light source, and other factors. The lighting apparatus of the embodiments and the variations thereof described above can therefore be used in a variety of apparatus.

For example, the linear or planar lighting apparatus with a hollow cavity according to the embodiments and the variations thereof described above can be used as a backlight source of a liquid crystal display (LCD), a typical illuminator, any illuminator for business use, a light source for image scanning, and an illuminator for other devices. For example, liquid crystal display devices, TV sets, and illuminating apparatus using any of the lighting apparatus of the embodiments and the variations thereof described above can be lightweight and thin, and the degree of uniformity over the lighting surface can be high, whereby the performance can be significantly improved.

In particular, the planar lighting apparatus with a hollow cavity according to the second embodiment and the variations thereof described above are suitable for local area dimming in a lighting apparatus formed by arranging a plurality of lighting apparatus and hence having a large lighting surface, and natural inter-area light diffusion can be achieved.

The present invention is not limited to the embodiments and the variations thereof described above, but a variety of changes and modifications can be made to the extent that they do not depart from the substance of the present invention.

The present application claims a priority based on Japanese Patent Application No. 2008-103990 filed on Apr. 11, 2008 and Japanese Patent Application No. 2008-103991 filed on Apr. 11, 2008, and the contents disclosed in the basic applications described above are incorporated by reference in the specification, the claims, and the drawings of the present application.

1-15. (canceled)

16. A lighting apparatus with a lighting surface comprising:
a light source configured to emit light having a narrow-angle light intensity distribution characteristic;
a diffuser plate disposed in a position spaced apart by a predetermined distance from an optical axis of the light emitted from the light source, the diffuser plate forming the lighting surface; and
a reflection member provided in a position facing the lighting surface so that a uniform illuminance distribution over the lighting surface is achieved, the reflection member including a level reflection surface substantially parallel to the optical axis and an inclined reflection surface inclined to the optical axis at a predetermined angle;
wherein a hollow region is formed between the diffuser plate and the reflection member;
the light emitted from the light source is reflected off the level reflection surface and the inclined reflection surface toward the diffuser plate; and
the ratio of a diffuse reflection component to a specular reflection component of the light reflected off the level reflection surface is greater than the ratio of the diffuse reflection component to the specular reflection component of the light reflected off the inclined reflection surface.

17. The lighting apparatus according to claim 16,
wherein the proportion of the specular reflection component of the light reflected off the inclined reflection surface changes according to the distance from the light source.

18. The lighting apparatus according to claim 16,
wherein the light intensity distribution characteristic of the light source is expressed by a function approximated by 1/sin² θ within an angular range from 45 degrees with respect to the optical axis to a half angle at half maximum of the light intensity distribution characteristic, and
the level reflection surface is formed to fall within the angular range.

19. The lighting apparatus according to claim 16,
wherein the inclined reflection surface inclined at the predetermined angle is formed such that an illuminated area of the inclined reflection surface per unit solid angle of the light emitted from the light source is constant.

20. The lighting apparatus according to claim 16,
further comprising a specular reflection member provided on the opposite side of the hollow region to the light source.

21. The lighting apparatus according to claim 16,
wherein the light source comprises a pair of light sources provided such that the light sources face each other and optical axes thereof coincide with each other, each of the light sources emitting light having the narrow-angle light intensity distribution characteristic,
the reflection member has the level reflection surface and the inclined reflection surface for each of the pair of light sources,
two hollow regions communicating with each other are formed between the diffuser plate and the reflection member, and
the light emitted from each of the pair of light sources is reflected off the corresponding level reflection surface and inclined reflection surface toward the diffuser plate.

22. The lighting apparatus according to claim 16,
wherein the light source is formed of a plurality of light sources arranged in a ring shape so that optical axes of the light sources intersect at a single point in a single plane, each of the light sources emitting light having the narrow-angle light intensity distribution characteristic,
the reflection member includes an inclined reflection surface provided around the center of the ring shape and inclined to the single plane at a predetermined angle and a level reflection surface provided around the inclined reflection surface, and
the light emitted from the plurality of light sources is reflected off the level reflection surface and the inclined reflection surface toward the diffuser plate.

23. The lighting apparatus according to claim 21,
wherein the height of a top portion of the inclined reflection surface is determined such that direct light from one of the pair of light sources does not impinge on the other light source.

24. The lighting apparatus according to claim 16,
wherein the light source radially emits light having a narrow-angle light intensity distribution characteristic along a predetermined flat plane,
the diffuser plate is disposed in a position spaced apart from the predetermined flat plane by a predetermined distance,
the reflection member has a level reflection surface provided around the light source and substantially parallel to the predetermined flat plane and an inclined reflection surface provided around the level reflection surface and inclined to the predetermined flat plane at a predetermined angle, and
the light emitted from the light source is reflected off the level reflection surface and the inclined reflection surface toward the diffuser plate.

25. The lighting apparatus according to claim 24,
wherein the proportion of the specular reflection component of the light reflected off the inclined reflection surface changes according to the distance from the light source.

26. The lighting apparatus according to claim 24,
wherein the inclined reflection surface inclined at the predetermined angle is formed such that an illuminated area of the inclined reflection surface per unit solid angle of the light emitted from the light source is constant.

27. A lighting apparatus comprising a plurality of lighting apparatuses, each of which is the lighting apparatus according to claim 24, arranged in an m×n matrix (m and n are integers greater than or equal to two).

28. The lighting apparatus according to claim 27,
wherein a space is created between a top portion of the reflection member and the diffuser plate at a boundary between the plurality of lighting apparatuses.
